(19) United States
(12) Patent Application Publication
(10) Pub. No.: US 2007/0063655 A1
(43) Pub. Date: Mar. 22, 2007

(54) Lamp for a motor vehicle headlight

(75) Inventors: Lukas Kupper, Aachen (DE); Benno Spinger, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE Philips Electronics N.V.

(21) Appl. No.: 10/556,003

(22) PCT Filed: Apr. 29, 2004
(86) PCT No.: PCT/IB04/50544

§ 371 Date: Nov. 8, 2005

(30) Foreign Application Priority Data
May 12, 2003 (EP) 03101302.2

(51) Int. Cl. H01J 61/30

(52) U.S. Cl. 313/634

(57) ABSTRACT

A lamp (10, 11) for a motor vehicle headlight is described. The lamp (10, 11) comprises a quartz bulb (3, 12, 17) narrowly enclosing a light source (1, 2) and possibly an outer bulb (4) surrounding said quartz bulb (3). Negative lenses (7, 8, 14, 15, 16) extending in the direction of a longitudinal axis (1.) of the lamp (10, 11) are present in or at the two lateral surfaces (6, 13) of the quartz bulb (12, 17) and/or of the outer bulb (4). These lenses (7, 8, 14, 15, 16) are designed such that the light source (1, 2) is optically reduced in size in at least one direction.

The invention relates to a lamp for a motor vehicle headlight and to a motor vehicle headlight with such a lamp.

A basic requirement for practically all motor vehicle headlights is that on the one hand the headlight should achieve as good as possible an illumination of the traffic space so as to provide the driver of the vehicle with a good view, while on the other hand dazzling of oncoming traffic must be avoided so as not to bring the oncoming traffic into danger. To exclude dazzling of the oncoming traffic with certainty, therefore, a so-called bright/dark limit, also denoted cut-off, is stipulated for the low beam function in relevant standards. It is to be heeded in the construction of lamps and headlights and in the installation and adjustment of the headlight in the vehicle that the traffic space below this cut-off only is illuminated. The bright/dark limit is observed in many cases by means of a suitable shading of the dark region by means of suitably positioned and shaped screen caps or blinds in the lamp itself or in the headlight. In both systems, the light radiated laterally from the lamp, i.e. issuing through the side surfaces which are horizontally mutually oppositely arranged in the assembled state of the lamp, is usually imaged in the region immediately below the bright/dark cut-off.

To achieve the best possible illumination of the traffic space in particular also in as long as possible a distance in front of the vehicle, the lamp or headlight should be constructed such that as much light as possible is imaged in the allowed region very closely below the bright/dark cut-off. Special constructions of the headlight, for example by means of a larger headlight diameter, may make it possible to redistribute the light such that the region immediately below the bright/dark cut-off is illuminated even more strongly. Unfortunately, however, additional measures for optimizing the radiation behavior of the headlight also lead to additional boundary conditions for the design of the headlight and the integration of the headlight in a certain design of a motor vehicle front, which are usually very expensive.

It is an object of the present invention to provide a lamp for a motor vehicle headlight by means of which a stronger illumination of the traffic space in the allowed region immediately below the bright/dark cut-off can be achieved substantially independently of the design of the headlight in which the lamp is incorporated.

This object is achieved by means of a lamp for a motor vehicle headlight which comprises a quartz bulb immediately enclosing a light source, possibly an outer bulb enclosing said quartz bulb, and two negative leases which extend in the direction of a longitudinal axis of the lamp and which are present in or at the lateral surfaces of the quartz bulb and/or the outer bulb, which surfaces are arranged so as to be horizontally mutually opposed in the incorporated state of the lamp, which lenses are constructed such that the light source is optically reduced in size in at least one direction.

Since the light issuing from the lateral surfaces of the lamp—and accordingly the image of the light source seen from the side—is radiated towards the region of the bright/dark cut-off, as was described above, the negative lenses reduce the images of the light source at the bright/dark cut-off in the side surfaces, for example shortening them in longitudinal direction and/or narrowing them perpendicularly to the longitudinal direction, whereby a higher luminance is achieved exactly in these regions. The optical reduction of the light source can thus achieve a better illumination of the traffic space also with conventional headlights, given the same total quantity of light. A real reduction in size of the light source is not necessary here, which would indeed not be possible as a rule for physical or constructional reasons. Instead, the lenses at the side surfaces of the lamp ensure that the headlight “sees” a smaller light source and images this reduced, virtual light source in the traffic space.

The lenses are preferably integrated into the relevant bulb by means of a suitable shaping of the bulb wall. Alternatively, however, separately manufactured lenses provided against the wall may be used.

The invention may be realized for a wide variety of lamp types. In a particularly preferred embodiment, this is a gas discharge lamp. Typical gas discharge lamps are, for example, the so-called HID (High Intensity Discharge) lamps such as, for example, high-pressure sodium lamps, or so-called MPXL (Micro Power Xenon Light) lamps. Such lamps usually have a discharge vessel consisting of a quartz bulb, which is filed with an inert gas, Electrodes extending in longitudinal lamp direction project into the quartz bulb from mutually opposed ends thereof, which electrodes terminate at some distance from one another. After an ignition achieved by means of a high voltage applied to the electrodes, a luminous discharge arc establishes itself between the electrodes, which is used as a light source. The quartz bulb of a gas discharge lamp is usually surrounded by an outer bulb which serves inter alia for screening off the UV radiation. It suggests itself in such gas discharge lamps to integrate the negative lenses in the lateral surfaces of the outer bulb, which is also made of quartz glass in most cases, or to fasten them to these surfaces.

Alternatively, the inner bulb may be provided with suitable lenses. This has the advantage that the lenses are closer to the light source and accordingly operate more efficiently. The disadvantage is, however, that the provision of such lenses in or at the inner bulb is technically more complicated and more expensive on the one hand, and that on the other hand each and every change in the geometry of the inner bulb at the same time changes other lamp parameters such as, for example, the temperature distribution in the inner bulb. This in its turn influences the formation of the discharge arc and thus also the light distribution. In contrast thereto, an introduction of lenses into the lateral surfaces of the outer bulb is comparatively simple and inexpensive and has no effect on the radiation and luminous efficacy of the light source itself.

In a further preferred embodiment, the lamp has a filament as its light source, for example an incandescent coil. A typical example of such a lamp is a halogen lamp such as the familiar H4 lamp. Such lamps usually have only one quartz bulb which closely surrounds the filament, at a certain distance to the filament. Such lamps usually have no further outer bulb, so that the lateral surfaces of the quartz bulb immediately enclosing the light source are themselves provided with the negative lenses. This is not to say, however, that filament lamps cannot also have an additional outer bulb and that the lateral lenses cannot be arranged at or in this outer bulb, or alternatively respective pairs of mutually co-operating lenses, one at the inner quartz bulb and one at the outer bulb each time.

The remaining dependent claims relate to further particularly advantageous embodiments and further developments of the invention.

In a particularly preferred embodiment, the negative lenses are constructed such that a curvature of each negative lens extends perpendicularly to the longitudinal axis of the lamp. This can be readily achieved as a rule by means of a flattening of the lateral surfaces of the quartz bulb or the outer bulb. As a rule, both the inner, quartz bulb and an outer bulb, if present, have a circular inner cross-sectional surface owing to their manufacture, i.e. the bulbs are constructed as cylindrical tubes in longitudinal lamp direction. When the outer side of the respective bulb is flattened, a negative, i.e. planar-concave lens is automatically formed in a simple manner, by means of which the light source is made to seem optically narrower when viewed from the side, To produce such a negatively acting lamp, however, it is also possible to provide a curvature on the outer side of the respective bulb. It is noted that a lens with a certain curvature or direction of curvature should also be understood to be a lens constructed such that it has an effect corresponding to such a curvature, for example in that it is constructed as a Fresnel lens for this purpose, within the context of the present publication, unless stated to the contrary.

In the case of lamps with incandescent coils, such as the conventional halogen lamps, such a negative lens ensures that the incandescent coil seems to be narrower. A particular advantage of such negative lenses with a curvature extending perpendicularly to the longitudinal axis of the lamp, however, is found in gas discharge lamps. The physical conditions inside gas discharge lamps always lead to the formation of a discharge arc which is curved upwards with a certain radius. This actual discharge arc curvature cannot be reduced by constructional measures because this would require a reduction in the diameter of the discharge vessel. This leads to crystallization of the quartz bulb because of the high temperature of the discharge arc, which would considerably shorten lamp life. The lateral negative lenses, however, reduce the curvature of the virtual luminous arc imaged into the traffic space, which in the end has the same effect as an actual reduction of the discharge arc curvature.

Preferably, the negative lenses alternatively or in addition each have a curvature extending parallel to the longitudinal axis of the lamp. A negative lens of this construction ensures that the light source, i.e. the coil or the discharge arc, seems to be shorter when viewed from the lateral surfaces than without such a lens. If the quartz bulb immediately enclosing the light source or an outer bulb, if present, is already shaped such that it has a corresponding curvature running parallel to the longitudinal axis of the lamp on the inside, such a negative lens may again be achieved by means of a simple flattening of the bulb wall at the horizontal lateral surfaces. In addition or alternatively, however, a curvature may be provided at the outer side for this purpose.

In a further preferred embodiment, the (inner) quartz bulb and/or the outer bulb, if present, comprise further lenses extending obliquely upwards and/or obliquely downwards and directly adjoining the horizontally mutually opposed lateral lenses, such that the light source is seen to be reduced in size when viewed from the respective lateral viewing directions slightly obliquely tilted with respect to the horizontal.

This may be comparatively simply achieved in a bulb whose wall has an internal curvature anyway, i.e. for example an elliptical, spherical, or cylindrical curvature, in that the bulb is provided with an outer surface in the region of the lateral surfaces which is polygonally shaped in cross-section, i.e. which is flattened not only laterally but also slightly obliquely in upward and/or downward direction.

In particular in the case of gas discharge lamps according to the invention, positive lens elements are preferably arranged inside the two lateral negative lenses in certain respective regions in relation to the longitudinal direction of the lamp. Certain standards, for example ECE-R99, prescribe that the discharge arc of a gas discharge lamp must have a greater width or diffuseness in a location, typically in the center between the electrodes. This may then be achieved by means of such an additional positive, for example convex lens arranged in the relevant location along the longitudinal axis, providing a widening of the image of the light source in this direction. Preferably, this positive lens element is given a rotationally symmetrical shape or the shape of a spherical segment Alternatively, it may be a cylindrically symmetrical lens element with an axis of symmetry of the cylinder extending substantially at right angles to the longitudinal axis of the lamp.

The invention will be explained in more detail below with reference to the accompanying drawings and advantageous embodiments. In the drawings:

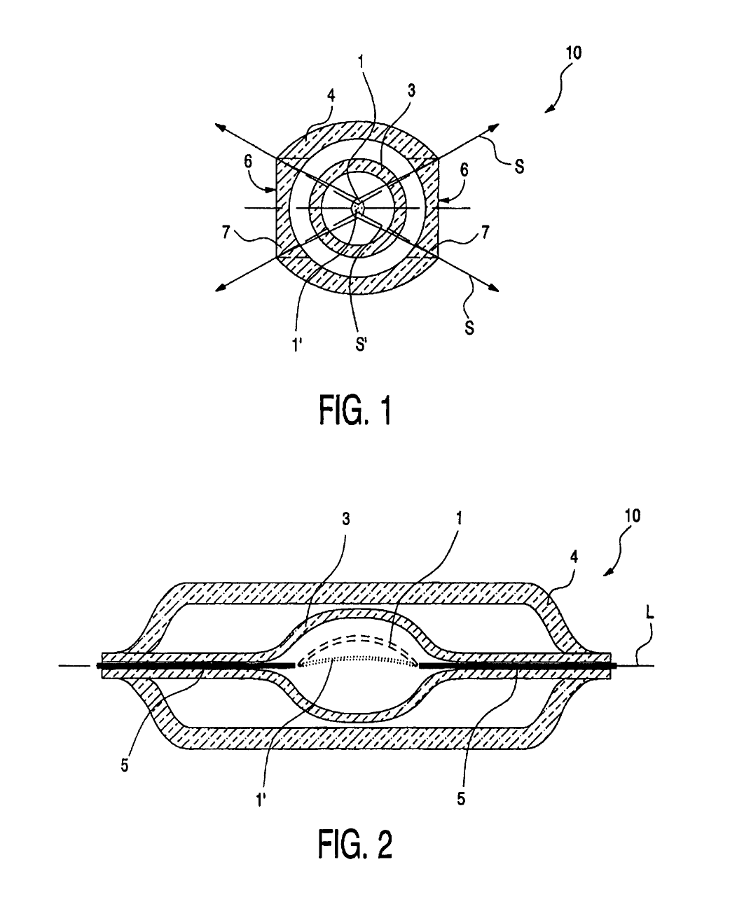

FIG. 1 is a diagrammatic cross-sectional view of a gas discharge lamp with a laterally flattened outer bulb in the region of the discharge arc,

FIG. 2 is a diagrammatic vertical longitudinal sectional view of the gas discharge lamp of FIG. 1,

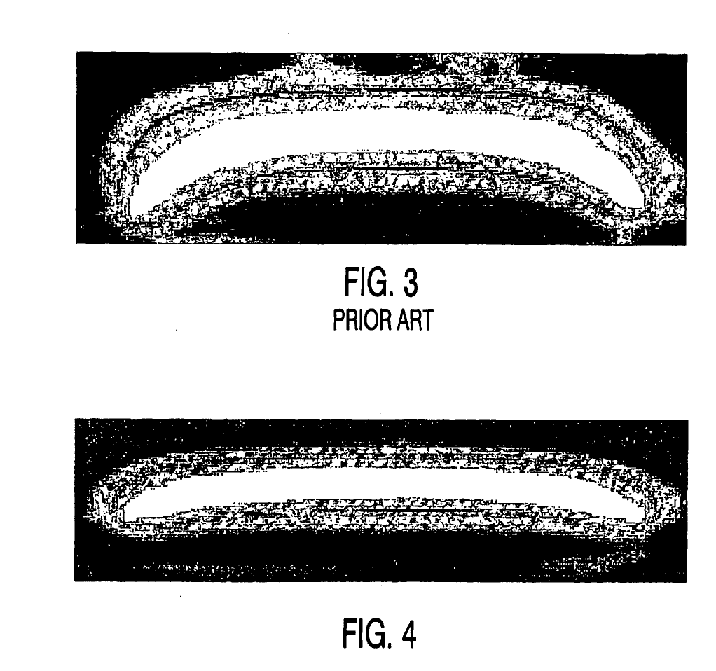

FIG. 3 is a luminous intensity image of the discharge arc of a conventional gas discharge lamp, viewed from the side,

FIG. 4 is a luminous intensity image of a discharge arc of a gas discharge lamp according to the invention, shown as in FIG. 3,

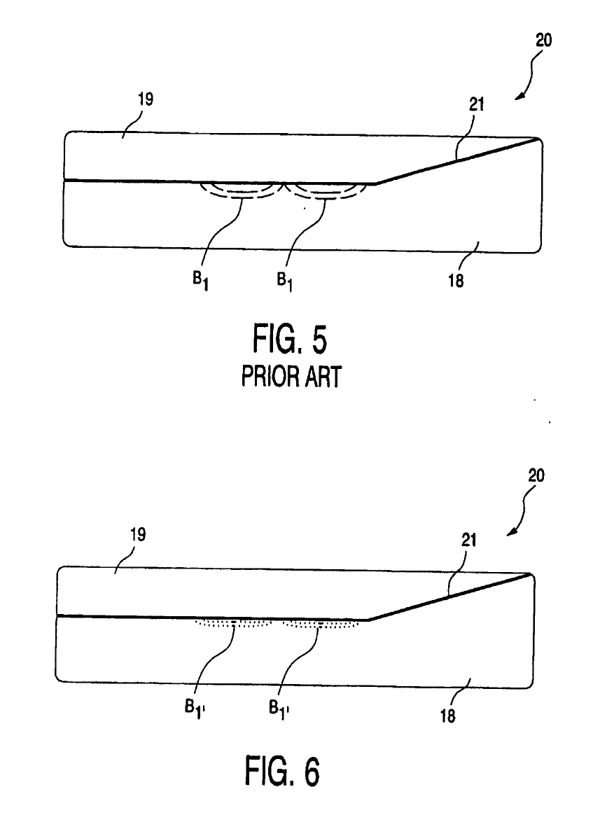

FIG. 5 diagrammatically shows the illumination of the traffic space by means of an image of the discharge arc of a prior-art gas discharge lamp,

FIG. 6 diagrammatically shows the illumination of the traffic space by means of an image of the discharge arc of a gas discharge lamp according to the invention,

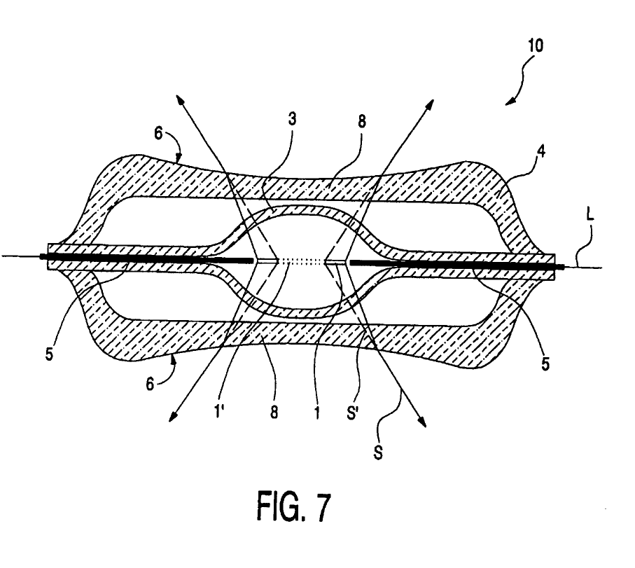

FIG. 7 is a diagrammatic horizontal longitudinal sectional view of a gas discharge lamp with an outer bulb having curved outer surfaces along the longitudinal axis,

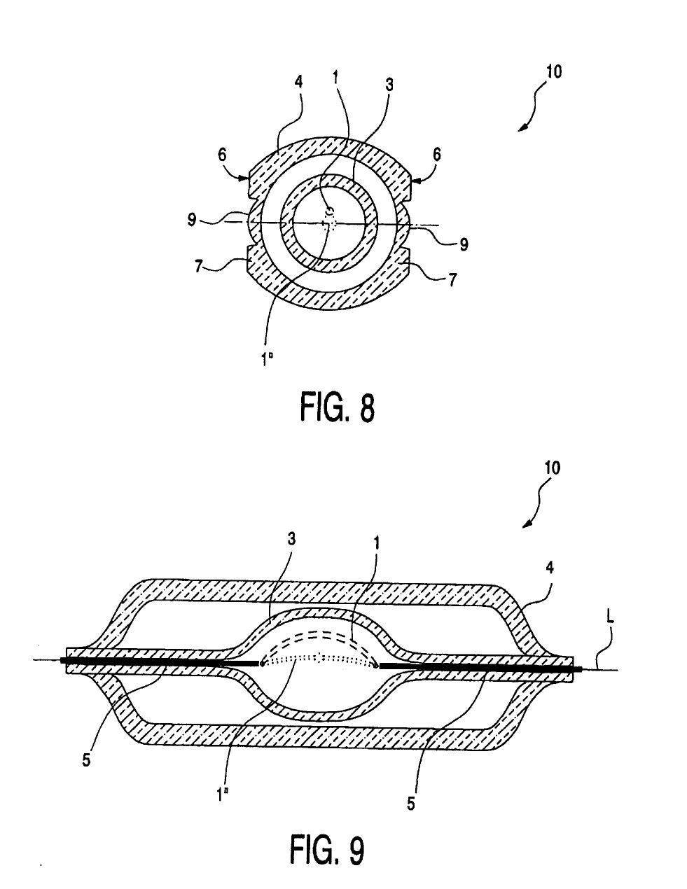

FIG. 8 is a cross-sectional view of a gas discharge lamp according to the invention in a further embodiment similar to FIG. 1,

FIG. 9 is a diagrammatic vertical longitudinal sectional view of the gas discharge lamp of FIG. 8,

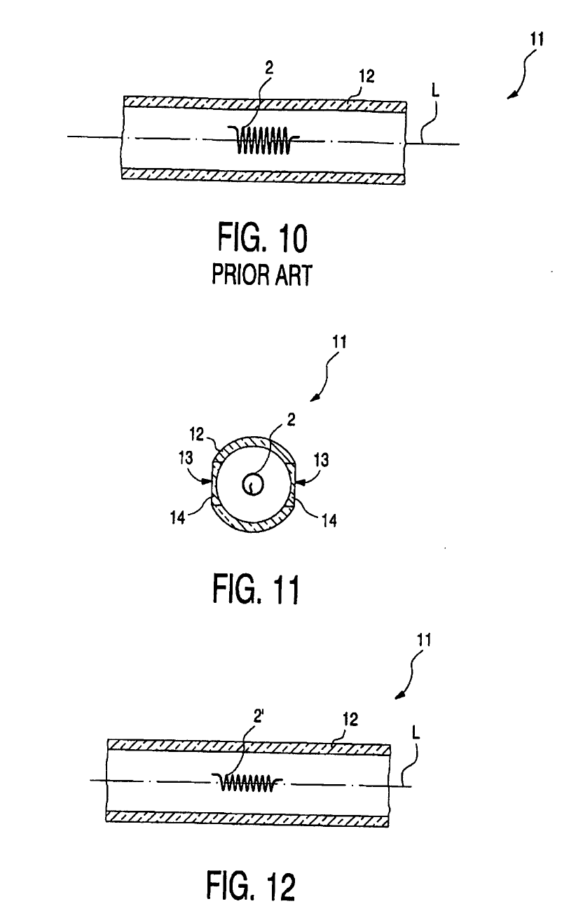

FIG. 10 is a diagrammatic cross-sectional view of part of a prior-art halogen lamp,

FIG. 11 is a diagrammatic cross-sectional view of a halogen lamp with an incandescent coil and a laterally flattened quartz bulb,

FIG. 12 is a diagrammatic vertical partial longitudinal sectional view of the halogen lamp of FIG. 11 showing the coil image visible through the negative lens from a lateral direction,

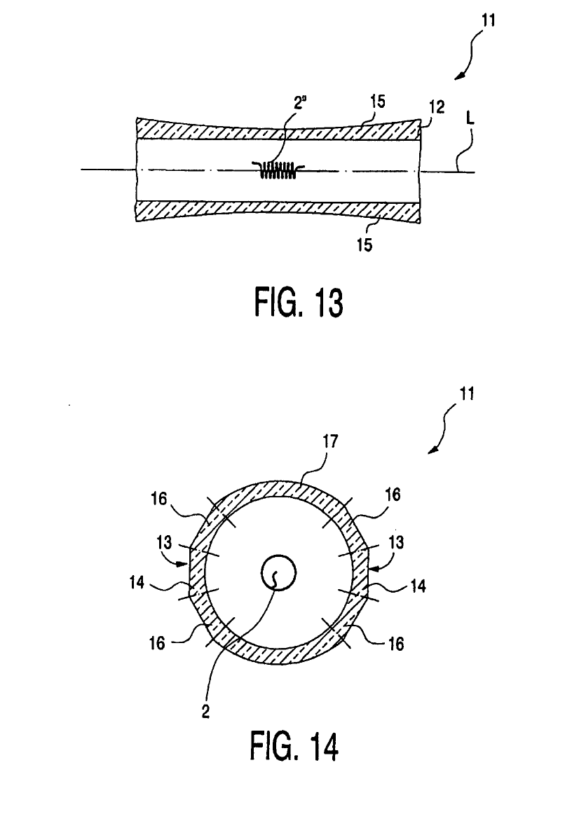

FIG. 13 is a diagrammatic horizontal partial longitudinal sectional view of a halogen lamp with negative cylindrical lenses integrated in the lateral outer walls in a father embodiment, showing the coil image visible through such a lens from a lateral direction, and

FIG. 14 is a diagrammatic cross-sectional view of halogen lamp similar to FIG. 11, but with an outer bulb that is partly polygonally shaped on the outside.

FIGS. 1 and 2 show the construction of a gas discharge lamp 10 according to the invention in cross-section and in vertical longitudinal section, with negative lenses 7 integrated into the lateral surfaces that are mutually opposed in horizontal direction, in accordance with the invention.

The lamp 10 is formed in usual manner from an inner quartz bulb 3, into which two electrodes 5 project from the mutually opposed ends in the longitudinal lamp direction L. This inner quartz bulb 3 forms the discharge vessel whose inner space is filled with an inert gas, The lamp 10 is ignited by the application of a high voltage to the electrodes 5, and a luminous discharge arc 1 establishes itself between the electrodes 5 in the interior of the quartz bulb 3. After ignition, the lamp 10 is usually operated on a low alternating voltage during subsequent operation.

The inner quartz bulb 3 is surrounded by an outer bulb 4 in conventional manner here, which outer bulb is, for example, also made from quartz and is connected to the inner bulb 3 at its two end portions. This outer bulb 4 serves inter alia for screening off the UV radiation arising during operation of the lamp 10.

An upwardly curved discharge arc 1 is always formed in such a gas discharge lamp 10 because of the physical conditions. The radius of curvature then usually lies between approximately 0.5 mm (for standard lamps) and approximately 0.7 mm (for mercury-free lamps). The high temperature of the discharge arc 1 and the melting point of the material of the quartz bulb 3 together render it impossible to choose the inner diameter of the quartz bulb 3 to be so small that the discharge arc 1 is forced into a straight shape. As will be explained in more detail below, however, a reduction of the radius of curvature is highly desirable for reasons of lighting technology.

Therefore, the lamp of FIGS. 1 and 2 is provided with lateral negative lenses 7 according to the invention. In the embodiment shown, the lateral surfaces 6 of the otherwise hollow cylindrical outer bulb 4 are externally flattened. This creates the desired negative lenses 7 in the lateral walls, the curvature of which is perpendicular to the longitudinal axis L of the lamp 10 in each case. This means that the lateral walls of the outer bulb 4 form respective planar-concave lenses 7, with the concave side on the inside.

These planar-concave lenses 7 achieve that the discharge arc 1 seems to be flattened when viewed from the side at right angles to the longitudinal axis L of the lamp 10. This effect is clarified in FIG. 1 by means of the boundary rays S starting from the upper and lower boundaries of the light source 1 and passing through the lenses 7, the actual paths of these boundary rays S being each represented by a solid-line arrow. As is shown, the boundary rays S are deflected upwards and downwards inside the planar-concave lens 7. An observer present outside and next to a lens 7 will only see the boundary rays S with the direction they have outside the lamp 10. He accordingly sees a virtual image 1 of the discharge arc 1 as would result from a continuation of the outer portions of the boundary rays S along the broken lines S′ towards the inside. Instead of the unaffected discharge arc 1 shown in broken lines in FIG. 2, the lateral observer will accordingly in total see an optically compressed, corrected discharge arc image 1′, which is represented by the dotted lines here.

FIGS. 3 and 4 show luminous intensity images of quartz glass bulb lamps of the D2S type for the purpose of comparison. The grey levels correspond to different luminous intensity values. FIG. 3 shows an image of a quartz glass bulb lamp according to the prior art, i.e. without lateral negative lenses. FIG. 4 on the other hand shows an image of a lamp of the same type, wherein negative lenses were provided through flattening of the side surfaces in the side walls of the outer bulb in the manner of the invention. A comparison of the pictures in FIGS. 3 and 4 immediately shows that the image visible from the outside, i.e. the (virtual) shape of the discharge arc 1, is substantially straighter in the modified lamp according to the invention than in the unmodified lamp.

The positive effects of this correction of the image 1′ of the discharge arc 1 visible from the side wilt become apparent from a comparison between FIGS. 5 and 6. Both Figures show the traffic space 20 in a projection plane perpendicular to the horizontal radiation direction of a headlight (not shown). This is a reflector-type headlight in the present case, in which a conventional lamp was inserted without lateral negative lenses in the one case (FIG. 5), and in which a lamp according to the invention was inserted in the other case (FIG. 6). The bright/dark cut-off 21 is indicated in each of the traffic spaces 20 shown, separating the upper, dazzling range 19 from the low-beam range 18, i.e. the illuminated traffic space. As in all headlights for right-hand traffic, the bright/dark cut-off 21 is angled obliquely upwards on the right-hand side, because the oncoming traffic to be protected against dazzling by the compliance with the bright/dark cut-off 21 passes on the left-hand side.

The reflection headlight is constructed in a usual manner such that the light radiated in upward direction from the lamp is reflected into the lower region of the low beam. The light coming from the discharge lamp in downward direction is either blocked by an additional screen or is also reflected into the lower region of the low beam. The light issuing through the side surfaces of the outer bulb, and accordingly the image B₁, B₁ of the discharge arc 1 visible from the lateral side of the lamp, is imaged in the region of the bright/dark cut-off 21 in the traffic space 20. Since the reflector is usually composed of several segments, the reflector images the discharge arc, which is actually present only once, several times next to one another or mutually overlapping in the traffic space. FIGS. 5 and 6, however, only show two images B₁, B₁ of the discharge arc 1 for greater clarity.

As was noted above, the light must on no account be radiated above the bright/dark cut-off 21 so as to avoid dazzling of the oncoming traffic. On the other hand, however, it is useful to image as much light as possible immediately at the bright/dark cut-off 21 so as to obtain as good as possible a view for the driver, especially in a range farther away in front of the vehicle.

As FIG. 5 clearly shows, the strongly curved shape of the images B₁, of the discharge arc means that the greatest, central portion of each image B₁ cannot lie as close to the bright/dark cut-off as is desired, because otherwise the ends of the images B, would lie above the bright/dark cut-off 21. By contrast, the images B_{1′} generated by the negative lenses arranged laterally at the lamp bulb can be positioned substantially closer to the bright/dark cut-off 21 over their entire length. The light is particularly well centered immediately below the bright/dark cut-off 21 thereby, which has the result that in particular the traffic space between 30 m and 75 m in front of the vehicle is better illuminated The driver can thus spot potential dangers more quickly and react more quickly accordingly, which leads to a corresponding improvement in traffic safety.

A better illumination of the region immediately below the bright/dark cut-off 21 can also be achieved by means of a shortening of the discharge arc. Such an optical shortening of the discharge arc 1 is achieved in that the lateral surfaces of the bulb 4 are formed as negative lenses whose curvatures run parallel to the longitudinal axis of the lamp, as is shown in a horizontal cross-section in FIG. 7. As is shown again with reference to the boundary rays S, S′, the observer from a lateral position sees not the actual discharge arc 1 but the image 1′ of a discharge arc that is optically shortened along the lamp axis L owing to the negative lenses 8. This accordingly provides a concentration of the light again when the discharge arc is imaged into the traffic space below the bright/dark cut-off 21, and thus a better illumination of a region farther removed in front of the vehicle.

A particularly good illumination is achieved by a combination of the above effects, i.e. by an optical reduction of the light source in both directions. Since a lamp 10 of FIG. 1 comprises negative lenses both with an (inner) curvature transverse to the lamp axis L and an (outer) curvature parallel to the lamp axis L as a result of the usual curvature of the inner side of the wall of the outer bulb 4, the image of the light source 1 of the lamp 10 is necessarily both compressed transversely to the lamp axis L and shortened parallel to the lamp axis L. This means that the preferred “double effect” is achieved here with a comparatively simple shaping of the outer side walls of the outer bulb 4. It is possible in principle, however, to introduce alternative negative lenses into the side walls, in particular lenses of complicated shape.

FIGS. 8 and 9 show a further embodiment of the invention. Basically what we have here is a discharge lamp 10 with flattened side surfaces 6 of the outer bulb 4 as in FIGS. 1 and 2. The difference with the lamp 10 of FIGS. 1 and 2 is, however, that positive lens elements 9 are additionally provided in the lateral surfaces 6, i.e. in the central region along the longitudinal axis L of the lamp 10. These are external rotationally symmetrical, i.e. hemispherical convex lenses. Since the inner side of the wall of the outer bulb is curved, a positive meniscus shape is obtained here transversely to the longitudinal lamp axis L.

These positive lens elements 9 have the effect that the discharge arc 1 exhibits a greater width exactly in the central region between the electrodes 5, and is accordingly more diffuse. Such a higher diffuseness of the discharge arc 1 in the central region is demanded by certain requirements. The effect of the lens elements 9 can be seen most clearly in the vertical longitudinal section of FIG. 9 where again the unchanged discharge arc 1 is represented by the broken lines and the image 1″ of the discharge arc modified by the negative lenses 7 with the centrally integrated positive lens elements 9 is represented in dotted lines.

FIGS. 10 to 13 highly diagrammatically show the use of negative lenses 14, 16 according to the invention in a halogen lamp 11 with a conventional incandescent coil 2. FIG. 10 merely serves as a comparison for FIGS. 12 and 13. The coil 2 is shown inside the quartz bulb 12, which encloses the coil 2 acting as a single, inner bulb. A further outer bulb is usually not present in such a halogen lamp 11. This does not exclude, however, that an additional outer bulb can be used in principle also in halogen lamps 11, which bulb will then enclose the inner quartz bulb 12, in which case the lenses will be provided in the outer bulb only, or in the inner quartz bulb 12 and in the outer bulb such that the respective lenses cooperate in a suitable manner. The lamp may be, for example, a H4 lamp, but for simplicity's sake only one of the two incandescent coils, in particular the low-beam coil, is shown here. The screen cap is also omitted for simplicity's sake.

FIG. 11 is a cross-sectional view of an embodiment of such a halogen lamp according to the invention. Here, again, negative lenses 14 are formed by flattening of the outer side of the walls of the quartz bulb 12 at the horizontally mutually opposed side surfaces 13, exactly as in the embodiment of a gas discharge lamp shown in FIG. 1. The lenses are again planar-concave lenses, the concave side being given by the curved shape of the inside of the wall of the quartz bulb 12.

FIG. 12 is a vertical longitudinal sectional view of the central portion of the lamp 11 of FIG. 11. The coil image 2′ visible through the lenses 14 in the lateral surfaces 13 is shown inside the lamp 11 here. A comparison between this virtual coil 2′ in FIG. 12 and the actual coil 2 in FIG. 10 shows that the coil image seen through the lens 14 is considerably thinner. This thinner coil image 2′ is accordingly imaged in the traffic space again by a reflector of the headlight, such that the light concentration accompanying the virtual reduction of the light source renders it possible to radiate more light immediately below the bright/dark cut-off.

FIG. 13 shows a modification in which the quartz bulb 12 is in addition laterally formed as a negative lens 15 with a curvature running in the longitudinal direction L of the lamp. When viewed through these negative lenses 15, the coil image 2″ is additionally shortened along the lamp axis L. This means that a further focusing takes place of the light finally radiated into the traffic space within a smaller region immediately below the bright/dark cut-off.

FIG. 14 shows a further embodiment in which the outer surface of the quartz bulb 17 is polygonally shaped in cross-section in the horizontally arranged regions. This means that the lamp has flattened regions each running as segments laterally along the lamp axis L, so that further negative lens elements 16 are formed next to one another each time obliquely downwards and obliquely upwards in addition to the directly horizontally arranged lenses 14. This has the result that the coil 2 is made thinner transversely to the lamp longitudinal axis L also when viewed slightly obliquely from above or from below. The light issuing obliquely downwards and upwards from the quartz bulb 17 immediately adjacent the direct lateral surfaces 13 is also imaged comparatively close to the bright/dark cut-off, so that also by these means an advantageous redistribution of the available light takes place towards the interesting region in the traffic space.

It is finally noted once more that the lamps 10, 11 shown and discussed in the Figures and the description are merely examples which may be varied to a considerable degree by those skilled in the art without departing from the scope of the invention. Thus, in particular, the negative lenses may be built up in an alternative shape in detail, for example as Fresnel lenses, so as to achieve the same effects. Similarly, the individual features of the various embodiments may be combined for forming new embodiments. Thus, for example, positive lens elements may also be provided within the negative lateral lenses on halogen lamps or other lamps. It is furthermore not necessary for the lenses to extend over the entire length and/or width of the respective side surfaces, but the lenses may be so integrated into the side surfaces, in particular in the case of lamps with several light sources, that only one of the light sources is imaged on a reduced scale.

The lamps according to the invention are particularly suitable as low beam lamps in motor vehicle headlights, but they may in principle be used for other purposes in other vehicle headlights.

It is finally pointed out for the sake of completeness that the use of the indefinite article “a” and “an” does not exclude the presence of a plurality of the relevant element, and that the use of the verb “to comprise” does not exclude the presence of further elements.

1. A lamp (10, 11) for a motor vehicle headlight
with a quartz bulb (3, 12, 17) immediately enclosing a light source (1),
possibly with an outer bulb (4) enclosing said quartz bulb (3), and
with two negative lenses (7, 8, 14, 15, 16) which extend in the direction of a longitudinal axis (L) of the lamp and which are present in or at two lateral surfaces (6, 13) of the quartz bulb (12, 17) and/or the outer bulb (4), which surfaces are arranged so as to be horizontally mutually opposed in the incorporated state of the lamp, which lenses are constructed such that the light source (1, 2) is optically reduced in size in at least one direction.

2. A lamp as claimed in claim 1, characterized in that the lamp (10) is a gas discharge lamp (10) with a discharge arc (1), enclosed by the quartz bulb (3), serving as the light source (1).

3. A lamp as claimed in claim 1, characterized in that the lamp (11) comprises at least one filament (2) as the light source (2).

4. A lamp as claimed in claim 1, characterized in that a curvature of the respective negative lenses (7, 14, 16) extends transverse to the longitudinal axis (L) of the lamp (10, 11).

5. A lamp as claimed in claim 1, characterized in that a curvature of the respective negative lenses (8, 15) each extends parallel to the longitudinal axis (L) of the lamp (10, 11).

6. A lamp as claimed in claim 1, characterized in that the quartz bulb (17) and/or the outer bulb comprise/comprises further lenses (16) that adjoin the lateral lenses (14) and that extend obliquely upwards and/or obliquely downwards.

7. A lamp as claimed in claim 6, characterized in that the quartz bulb (17) and/or the outer bulb comprise/comprises an outer side that is polygonally shaped in cross-section in the region of the lateral surfaces.

8. A lamp as claimed in claim 1, characterized by positive lens elements (9) arranged within the two lateral negative lenses (7) in respective defined regions in relation to the longitudinal direction (L) of the lamps.

9. A lamp as claimed in claim 8, characterized in that the positive lens elements (9) are rotationally symmetrical in shape.

10. A lamp as claimed in claim 8, characterized in that the convex lens elements are cylindrically symmetrically shaped with a cylinder axis of symmetry extending essentially at right angles to the longitudinal axis of the lamp.

11. A motor vehicle headlight with a lamp as claimed in claim 1.
